(19) United States
(12) Patent Application Publication
(10) Pub. No.: US 2013/0054892 A1
(43) Pub. Date: Feb. 28, 2013

(54) IMAGE PROCESSING APPARATUS

(71) Applicant: Takanori Kannari, Osaka (JP)

(72) Inventor: Takanori Kannari, Osaka (JP)

(73) Assignee: SHARP KABUSHIKI KAISHA, Osaka (JP)

(21) Appl. No.: 13/588,078

(22) Filed: Aug. 17, 2012

(30) Foreign Application Priority Data
Aug. 30, 2011 (JP) 2011-186770

(51) Int. Cl. G06F 12/08

(52) U.S. Cl. 711/114; 711/E12.019

(57) ABSTRACT

In a shared management information area of the HDD, management information is recorded at the time of activating a multi-functional peripheral. The RAID controller copies the management information stored in the shared management information area in a mirroring information area. Then, at the time of activating the multi-functional peripheral, the RAID controller compares information of the mirroring information area of each HDD with the management information of the shared management information area, and when content thereof corresponds with each other, performs activation normally, and in the case of not corresponding with each other, judges the HDD as having a use history in the past and separates the HDD from a control target as well as performing warning display.

### CROSS-NOTING PARAGRAPH

This non-provisional application claims priority under 35 U.S.C. §119(a) on Patent Application No. 2011-186770 filed in JAPAN on Aug. 30, 2011, the entire contents of which are hereby incorporated herein by reference.

### FIELD OF THE INVENTION

The present invention relates to an image processing apparatus for performing image output, which is applicable, for example, to a multi-functional peripheral including a plurality of image processing functions.

### BACKGROUND OF THE INVENTION

As an image processing apparatus, a multi-functional peripheral including a plurality of image processing functions such as a copy function, a printer function, an image scanner function and a facsimile function has been known.

There are many multi-functional peripherals including HDDs (Hard Disk Drive) for saving data. Along with increased capacity of the HDD in recent years, there is increased opportunity to use the HDD also for as a server for saving image data at the time of copying by using a copy function of a multi-functional peripheral and a file in a PC of a user. In such a situation, since it is possible to prevent data loss by using a RAID (Redundant Arrays of Inexpensive Disks) system even in the event of failure of the HDD, the RAID system has been mounted in the HDD of the multi-functional peripheral.

In the RAID system, it is possible to perform mirroring of data in an HDD by mounting a RAID controller with a mirroring function. Mirroring is to write same data in a plurality of HDDs, so that there are HDDs having the same information all the time, and even in the event of failure of one of the HDDs, an operation is continued to be performed by data of other HDD. There are some models of image processing apparatuses such as multi-functional peripherals in which a function to perform mirroring is incorporated for preserving important data and the like.

In order to construct the RAID, a controller for RAID control (referred to as RAID controller) records management information for identifying and managing an HDD in a part of an area in each HDD, and performs control based on the management information. The RAID controller then mirrors such management information to be recorded in a plurality of HDDs. The management information serves as mirroring information.

As a conventional example, a duplexing disk system disclosed in Japanese Laid-Open Patent Publication No. 3-259346 has been known. Duplexing means mirroring, and management information is recorded in the duplexing disk system, and a state of each HDD is grasped from content thereof at the time of activation so that mirroring operation is performed.

However, in the mirroring information, only information relating to RAID is recorded and identification information or the like such as model information of a multi-functional peripheral is not recorded. Therefore, for example, in a case where an HDD which has a history of being used in a multi-functional peripheral of one model is installed in a multi-functional peripheral of a different model, a RAID controller cannot recognize that the HDD has been used in the one model after powering on the multi-functional peripheral. Therefore, in the case of installing an HDD in a multi-functional peripheral, when the HDD which has been used in the one model is installed, a trouble such that the RAID controller overwrites data of the HDD may occur.

### SUMMARY OF THE INVENTION

An object of the present invention is to provide an image processing apparatus which includes management information which can be shared by a RAID controller and a controller of the image processing apparatus, and copies specific management information to mirroring information of an HDD, so that appropriate judgment is made whether or not the HDD is normal by comparing shared management information with the mirroring information, thus managing and operating the HDD safely.

An object of the present invention is to provide an image processing apparatus comprising: an image processing apparatus controller for controlling an operation of an image processing apparatus body; a plurality of HDDs constituting RAID; and a RAID controller for controlling the plurality of HDDs, wherein a part of a storage area of each of the HDDs serves as a shared management information area which is able to be accessed by both the image processing apparatus controller and the RAID controller, the RAID controller controls mirroring among the plurality of HDDs as well as storing mirroring information for identifying and managing each of the HDDs in each of the HDDs, and copies specific management information stored in the shared management information area in an area where the mirroring information is stored.

Another object of the invention is to provide the image processing apparatus, wherein the image processing apparatus controller records, at the time of activating the image processing apparatus, predetermined identification information of the image processing apparatus in the shared management information area as the specific management information, and the RAID controller compares, in each of the HDDs, information in the area where mirroring information is stored with the identification information recorded in the shared management information area at the time of the activation and judges whether or not the HDD as a target of the comparison is a normal HDD for constituting the RAID based on a result of the comparison.

Another object of the invention is to provide the image processing apparatus, wherein a display panel for displaying information is included, the RAID controller compares the specific management information copied in the past which is in the area where the mirroring information is stored with the specific management information stored in the shared management information area at the time of the activation, and judges, when a result of the comparison does not show correspondence, that the HDD to be a target for the comparison is abnormal, and the image processing apparatus controller performs warning display on the display panel according to the judgment by the RAID controller and separates the HDD which has been judged as abnormal from the control target.

Another object of the invention is to provide the image processing apparatus, wherein the RAID controller judges, when the specific management information is not recorded in the area where the mirroring information is stored, that the HDD as a target for the comparison is normal, and copies the specific management information stored in the shared management information area in the area where the mirroring information is stored, and the image processing apparatus controller normally activates the image processing apparatus according to the judgment by the RAID controller.

Another object of the invention is to provide the image processing apparatus, wherein the RAID controller compares the specific management information copied in the past which is in the area where the mirroring information is stored with the specific management information stored in the shared management information area at the time of the activation, and judges, when a result of the comparison shows correspondence, that the HDD to be a target for the comparison is normal, and the image processing apparatus controller normally activates the image processing apparatus according to the judgment of the RAID controller.

### BRIEF DESCRIPTION OF THE DRAWINGS

FIG. 1 is a diagram showing a relation between a multi-functional peripheral controller and an HDD when there is no RAID system provided;

FIG. 2 is a diagram explaining a configuration of a multi-functional peripheral provided with the RAID system;

FIG. 3 is a diagram explaining an example in which a mirroring kit is attached to the multi-functional peripheral for the first time;

FIG. 4 is another diagram explaining an example in which the mirroring kit is attached to the multi-functional peripheral for the first time;

FIG. 5 is still another diagram explaining an example in which the mirroring kit is attached to the multi-functional peripheral for the first time;

FIG. 6 is still another diagram explaining an example in which the mirroring kit is attached to the multi-functional peripheral for the first time;

FIG. 7 is still another diagram explaining an example in which the mirroring kit is attached to the multi-functional peripheral for the first time;

FIG. 8 is a diagram explaining replacement processing of the HDD in the event of HDD failure after constructing the RAID system;

FIG. 9 is another diagram explaining replacement processing of the HDD in the event of HDD failure after constructing the RAID system;

FIG. 10 is still another diagram explaining replacement processing of the HDD in the event of HDD failure after constructing the RAID system;

FIG. 11 is still another diagram explaining replacement processing of the HDD in the event of HDD failure after constructing the RAID system;

FIG. 12 is still another diagram explaining replacement processing of the HDD in the event of HDD failure after constructing the RAID system;

FIG. 13 is still another diagram explaining replacement processing of the HDD in the event of HDD failure after constructing the RAID system;

FIG. 14 is a diagram showing a state where a mirroring kit which has a use history in other model is newly attached to a multi-functional peripheral;

FIG. 15 is another diagram showing a state where the mirroring kit which has a use history in other model is newly attached to the multi-functional peripheral;

FIG. 16 is still another diagram showing a state where the mirroring kit which has a use history in other model is newly attached to the multi-functional peripheral;

FIG. 17 is still another diagram showing a state where the mirroring kit which has a use history in other model is newly attached to the multi-functional peripheral;

FIG. 18 is a diagram showing a state where an HDD having an attachment history is used in the event of HDD failure;

FIG. 19 is another diagram showing a state where the HDD having an attachment history is used in the event of HDD failure;

FIGS. 20A, 20B and 20C are diagrams explaining a configuration of the RAID system in an embodiment of the present invention;

FIG. 21 is a flowchart for explaining a processing example of an image processing apparatus according to the present invention;

FIG. 22 is a flowchart for explaining the processing example of the image processing apparatus according to the present invention, which is a diagram that follows FIG. 21;

FIG. 23 is a flowchart for explaining the processing example of the image processing apparatus according to the present invention, which is a still another diagram that follows FIG. 21; and

FIG. 24 is a diagram showing a display example of a display panel of the multi-functional peripheral at the time of attaching a used HDD having a use history.

### PREFERRED EMBODIMENTS OF THE INVENTION

An embodiment of an image processing apparatus according to the present invention is able to be implemented as a multi-functional peripheral including a plurality of image processing functions such as a copy function, a printer function, a facsimile function and the like. Although, description will be given hereinafter for the multi-functional peripheral as an example, the image processing apparatus according to the present invention may be configured as an apparatus with a specific image processing function of a copier, a printer, a facsimile machine, etc.

The multi-functional peripheral is provided with a RAID controller which controls RAID, and the RAID controller includes a function to control and mirror two or more HDDs. A part of a recording area in the HDD is configured to serve as an area which can be accessed by both a controller controlling a multi-functional peripheral body (referred to as a multi-functional peripheral controller) and the RAID controller controlling the RAID, and shared management information of the both controllers is saved in the area. Thereby, both the RAID controller and the multi-functional peripheral controller are able to share the information. A use history of an HDD is appropriately grasped by using the shared management information so the HDD is managed and operated safely.

Here, first, description will be given for a concept of the RAID.

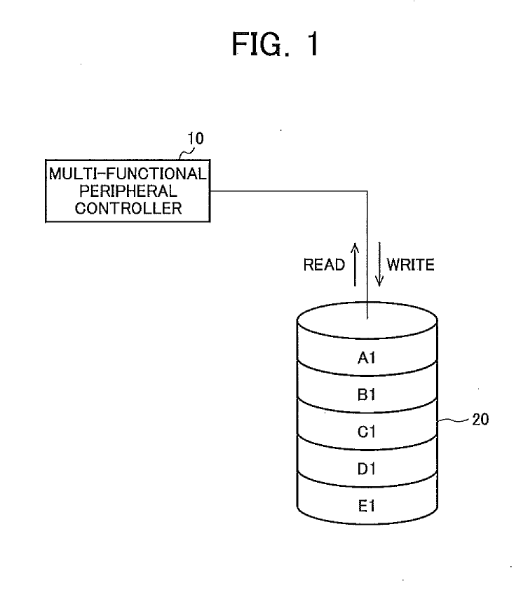

FIG. 1 is a diagram explaining a relation between the multi-functional peripheral controller and the HDD when there is no RAID system provided. In FIG. 1, 10 denotes a multi-functional peripheral controller provided on a controller board, and 20 denotes an HDD installed on a body of a multi-functional peripheral.

The multi-functional peripheral controller 10 is a controller which controls a multi-functional peripheral body, and has a CPU, a ROM, a RAM and the like formed on a board for performing a program stored in the ROM to control various operations such as image processing of the multi-functional peripheral. The multi-functional peripheral includes image processing means to execute image processing functions such as a copy function, a printer function, a scanner function, a facsimile function, an image transmission/reception function and the like, and is provided with a display panel as display means for displaying various information. The multi-functional peripheral controller 10 corresponds to an image processing apparatus controller of the present invention which controls an operation of an image processing apparatus body.

As shown in FIG. 1, in the multi-functional peripheral without the RAID system, the multi-functional peripheral controller 10 reads and writes data from and to the one HDD 20. That is, the multi-functional peripheral controller 10 directly accesses the one HDD 20. In this case, in the event of failure of the HDD 20, the HDD 20 is not capable of communicating with the multi-functional peripheral controller 10, so that an operation of the multi-functional peripheral controlled by the multi-functional peripheral controller 10 is stopped, and in some cases, there is a possibility that user data stored in the HDD 20 is lost.

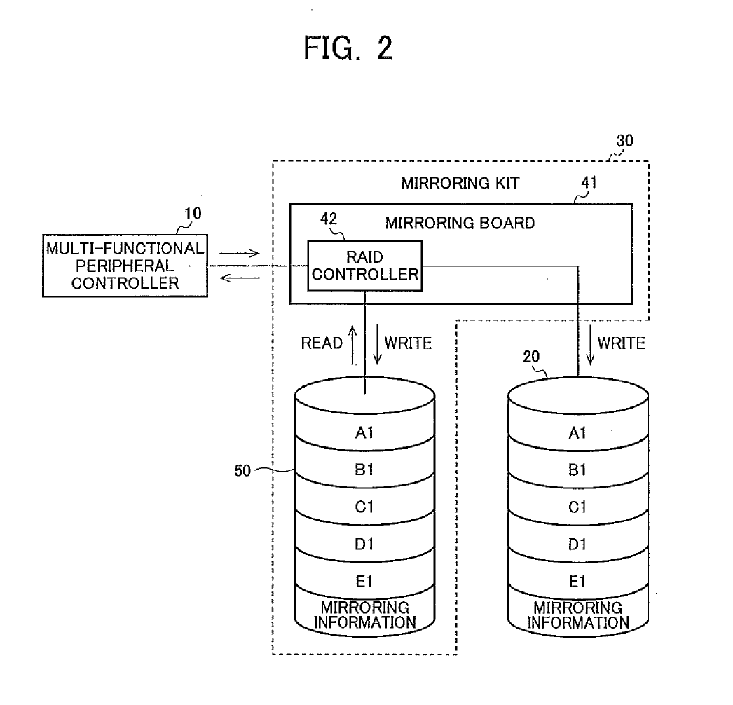

FIG. 2 is a diagram explaining a configuration of a multi-functional peripheral provided with the RAID system.

The RAID system is composed of a mirroring board 41 in which a RAID controller 42 is mounted, and an HDD 50. Such a configuration of the mirroring board 41 on which a RAID controller 42 is mounted, and the HDD 50 is referred to as a mirroring kit 30. Hereinafter, the HDD 20 provided in the multi-functional peripheral body serves as an HDD on a body side, and an HDD 50 included in the mirroring kit 30 serves as the HDD 50 on a mirroring kit side.

By including the mirroring kit 30, the multi-functional peripheral controller 10 is able to access the two HDDs 20 and 50 through the RAID controller 42 on the mirroring board 41. Further, mirroring information for identifying and managing the both HDDs is written in the both HDDs 20 and 50. The mirroring information is written in each of the HDDs 20 and 50 at the same time. Thereby, even when there is failure occurred in one HDD, the information of the other HDD is able to be used, so that data loss will not be occurred even with the failure of the one HDD.

Next, description will be given for the mirroring information. The mirroring information is information that is written in the both HDDs 20 and 50 for identifying and managing the HDD when the mirroring kit 30 is newly installed on the multi-functional peripheral, at the timing when the multi-functional peripheral is powered on after the installation. Once the mirroring information is written, the RAID controller 42 thereafter controls the RAID based on the mirroring information. Since the mirroring information is quite important information, it is preferable to store it in an area which cannot be directly accessed by the multi-functional peripheral controller 10.

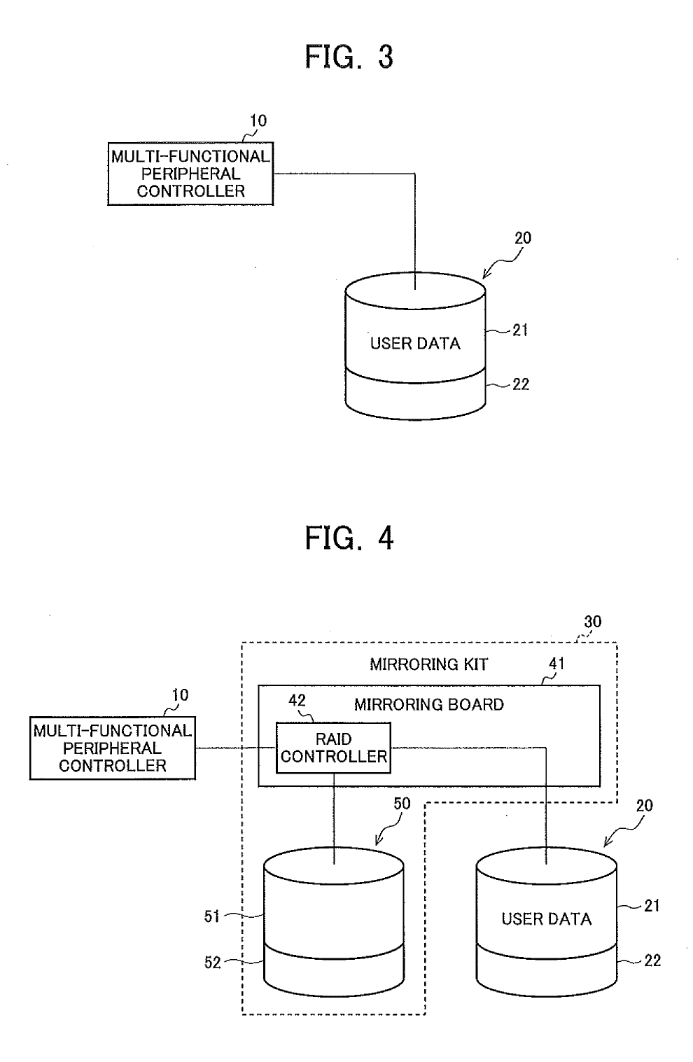

FIG. 3 to FIG. 7 are diagrams explaining examples in which a mirroring kit is attached to a multi-functional peripheral for the first time. In this configuration, explained is a common operation in a case where a shared management information area being a characteristic of the present invention is not included.

FIG. 3 is a diagram showing a state of a multi-functional peripheral before attaching a mirroring kit, and in the HDD 20 on the body side of the multi-functional peripheral, there is no mirroring information in a mirroring information area 22 which should store the mirroring information.

FIG. 4 shows a state where the mirroring kit 30 is newly attached to the multi-functional peripheral. In the HDD 20 on the multi-functional peripheral body side, there are a user data area 21 for storing user data and the mirroring information area 22, however, there is no mirroring information in the mirroring information area 22 at the time as described above. Moreover, also in the HDD 50 in the mirroring kit 30, there are a user data area 51 which should store user data and a mirroring information area 52, however, there is no mirroring information in the mirroring information area 52.

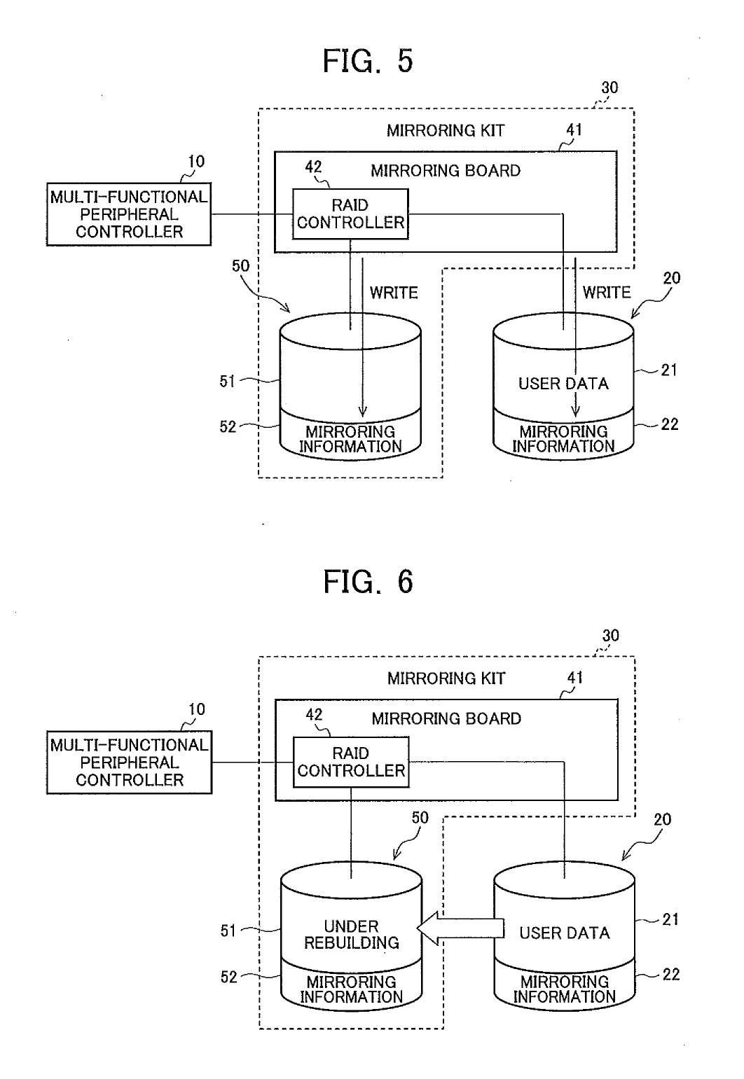

Here, when the multi-functional peripheral is powered on, as shown in FIG. 5, the RAID controller 42 writes mirroring information in each of the HDDs 20 and 50 because there is no mirroring information in the mirroring information areas 22 and 52 of the both HDDs 20 and 50.

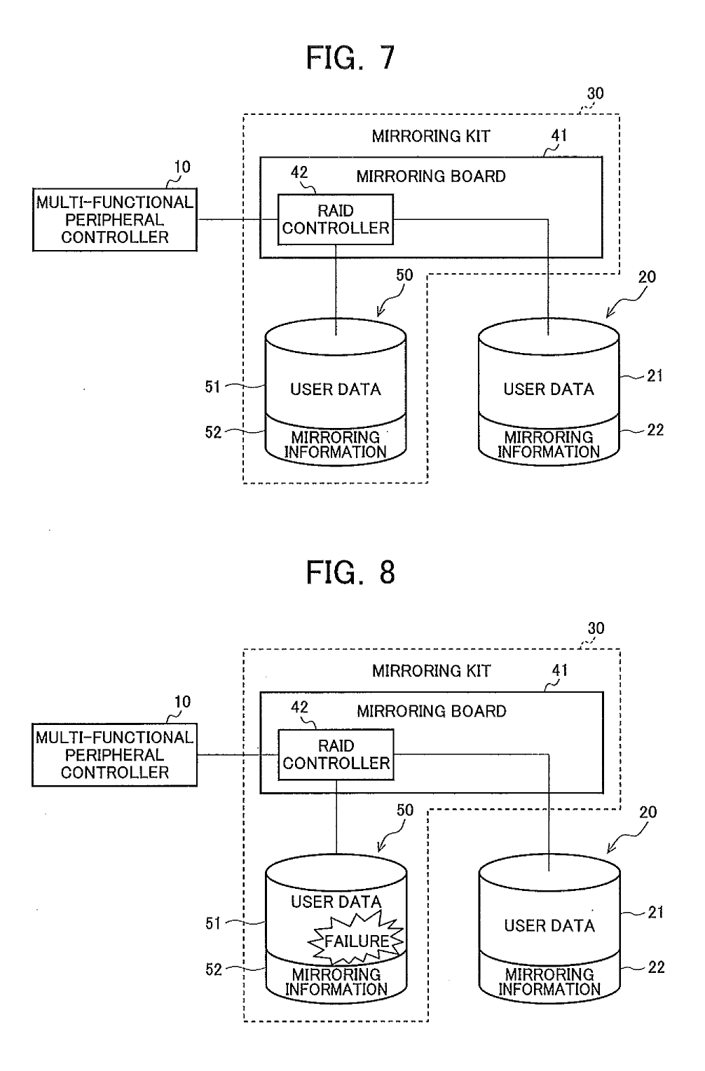

Subsequently, as shown in FIG. 6, the RAID controller 42 copies all user data of the HDD 20 on the multi-functional peripheral body side to the HDD 50 on the mirroring kit side for storing in the user data area 51 of the HDD 50. This is called “rebuild”. Then, after the elapse of a certain period of time, when the all user data is copied, content of the user data of the two HDDs 20 and 50 comes to exact the same as shown in FIG. 7.

Next, description will be given for replacement processing of an HDD in the event of HDD failure after constructing the RAID system shown in the above FIG. 7, with reference to FIG. 8 to FIG. 13. In FIG. 8, in the event of failure of either of the HDD 20 or 50, the RAID controller 42 detects the failure and notifies the multi-functional peripheral controller 10 of that. Here, it is assumed a case of failure of the HDD 50 on the mirroring kit side. The multi-functional peripheral controller 10 which received the notification of the failure displays on a display panel or the like of the multi-functional peripheral the failure of the one HDD 50 and prompts a user to replace the HDD 50, or the like.

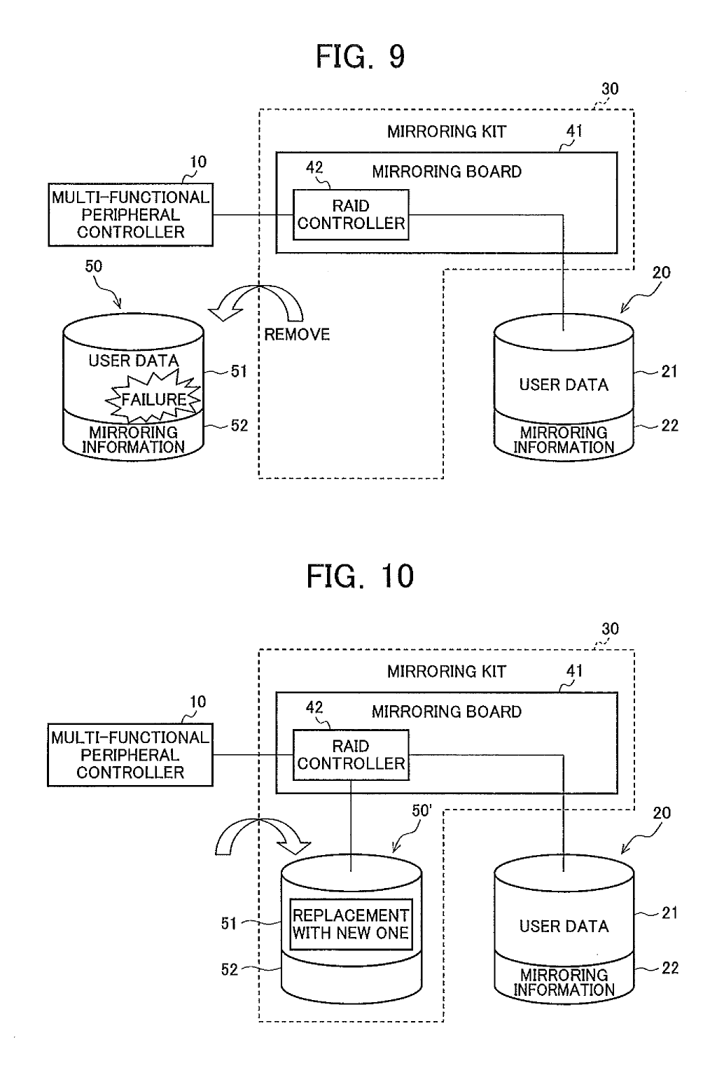

FIG. 9 shows a state where the failed HDD 50 is removed from the multi-functional peripheral. Then, FIG. 10 shows a state where a new HDD 50′ is installed in the mirroring kit 30.

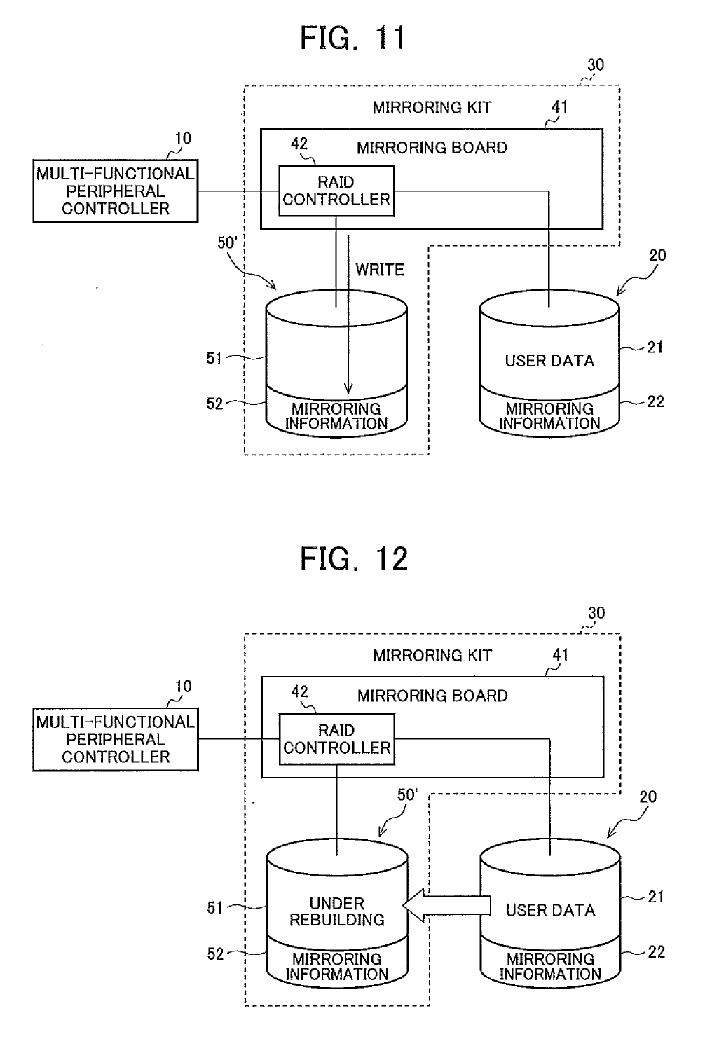

In the new HDD 50′, there is of course no mirroring information on a mirroring information area 52 thereof. When the multi-functional peripheral is thereafter turned on, as shown in FIG. 11, the RAID controller 42 writes mirroring information in the mirroring information area 52 of the new HDD 50′ installed on the mirroring kit 30.

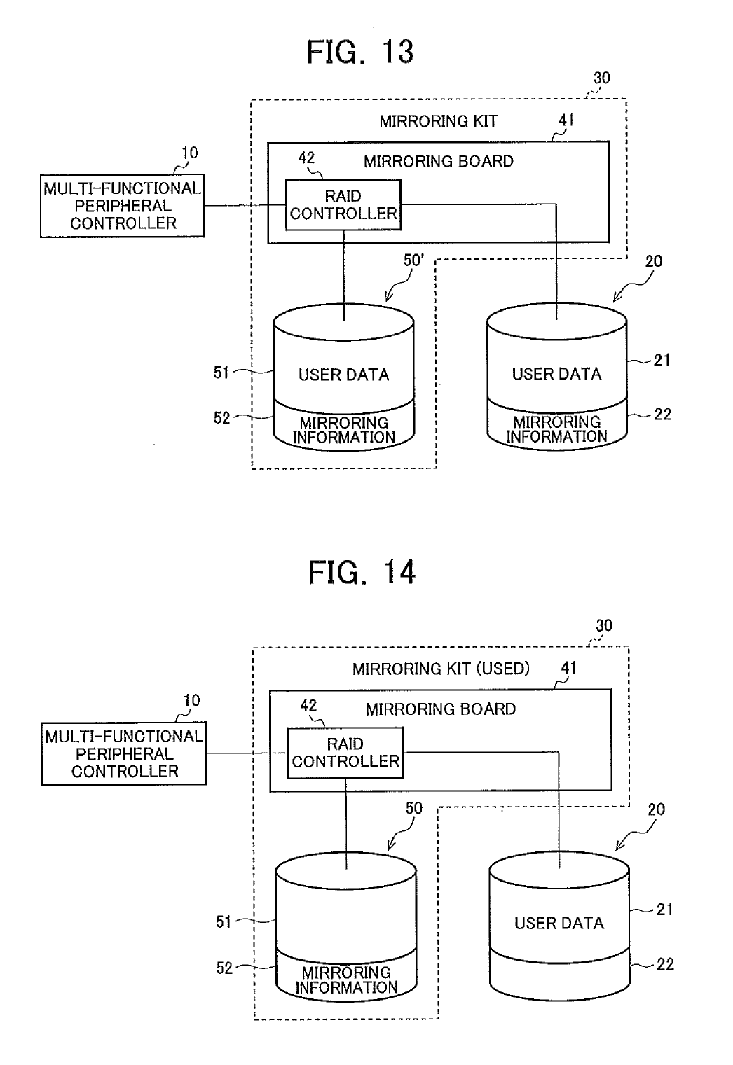

Then, thereafter, as shown in FIG. 12, the RAID controller 42 stars to rebuild the HDD 50′ on the mirroring kit side from the HDD 20 on the multi-functional peripheral body side. Then, after the elapse of a certain period of time, when all user data of the HDD 20 on the body side is copied to the new HDD 50′, content of the user data areas 21 and 51 of the two HDDs 21 and 51 come to exact the same content as shown in FIG. 13, and this state means complete recovery of the RAID system.

Next, description will be given for two prohibited matters in installation and replacement of an HDD.

As a first point, it is prohibited to attach to a multi-functional peripheral to which the mirroring kit 30 is not attached a used mirroring kit 30 which has a use history in other model. The details thereof will be described using FIG. 14 to FIG. 17. Here, description will also be given for a common state where the shared management information area according to the present invention is not provided as an example.

FIG. 14 shows a state where a used mirroring kit 30 which has a use history in other model is newly attached to a multi-functional peripheral to which the mirroring kit 30 is not attached (for example, a multi-functional peripheral in a state shown in FIG. 3). In the user data area 21 of the HDD 20 on the multi-functional peripheral body side, user data is written, however, there is no mirroring information in the mirroring information area 22 thereof. In the newly attached used mirroring kit 30, there is mirroring information which has been written in a multi-functional peripheral of the other model in the past, in the mirroring information area 52 of the HDD 50. Furthermore, in the user data area 51, there is no data, or there is data different from the user data on the multi-functional body side.

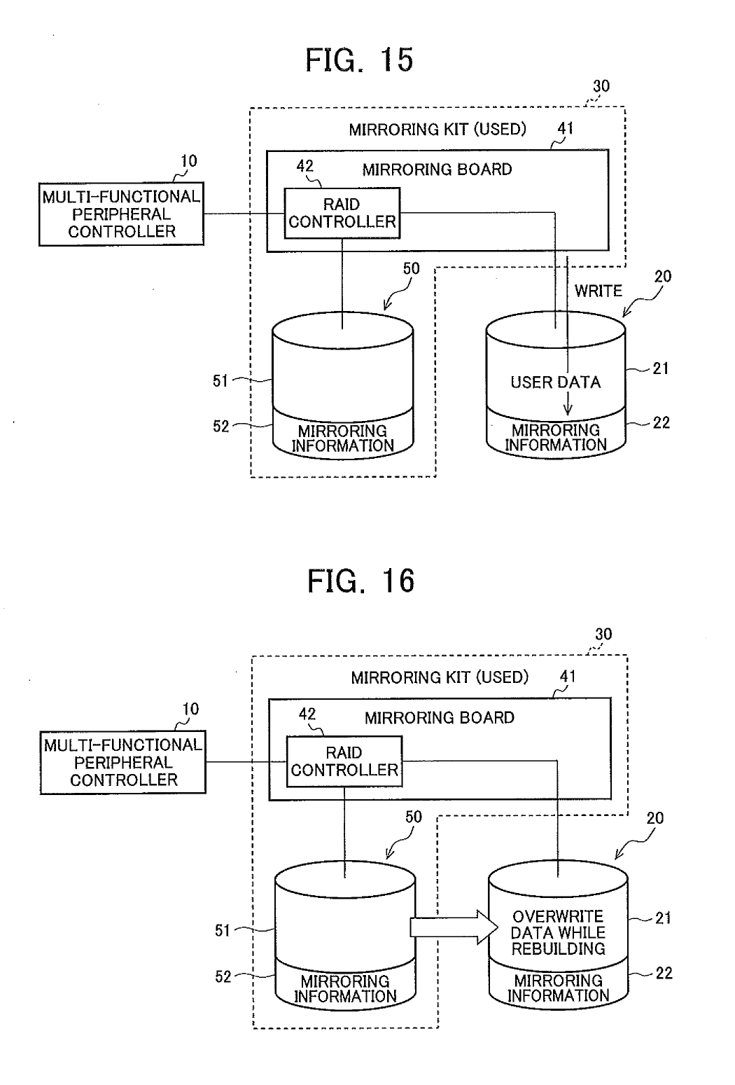

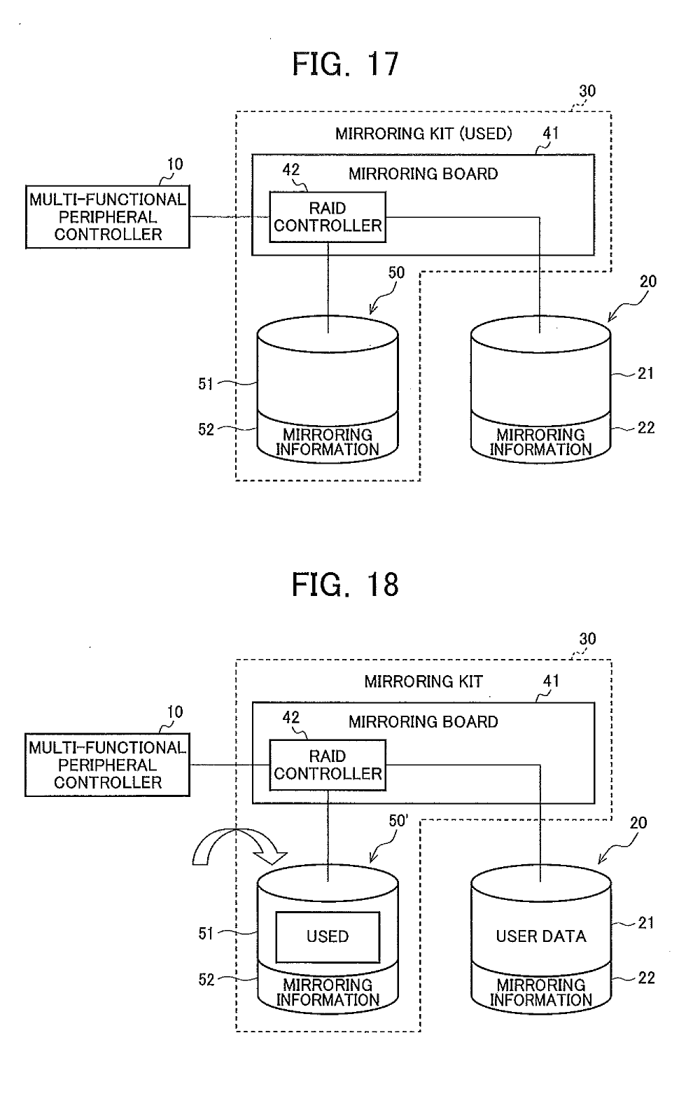

When the multi-functional peripheral is powered on in this state, as shown in FIG. 15, since there is no mirroring information in the HDD 20 on the multi-functional peripheral side, the RAID controller 42 writes the mirroring information of the HDD 50 on the mirroring kit side in the mirroring information area 22 of the HDD 20 on the multi-functional peripheral body side. As shown in FIG. 16, then, the RAID controller 42 starts to operate to rebuild the HDD 20 on the multi-functional peripheral body side from the HDD 50 on the mirroring kit side. This is because the RAID controller 42 operates while treating the HDD 50 on the mirroring kit side where there is the mirroring information as a copy source. As a result, as shown in FIG. 17, the user data of the HDD 50 on the mirroring kit side is overwritten to the HDD 20 on the multi-functional peripheral body side so that the user data which has been originally written in the HDD 20 on the multi-functional peripheral body side is erased.

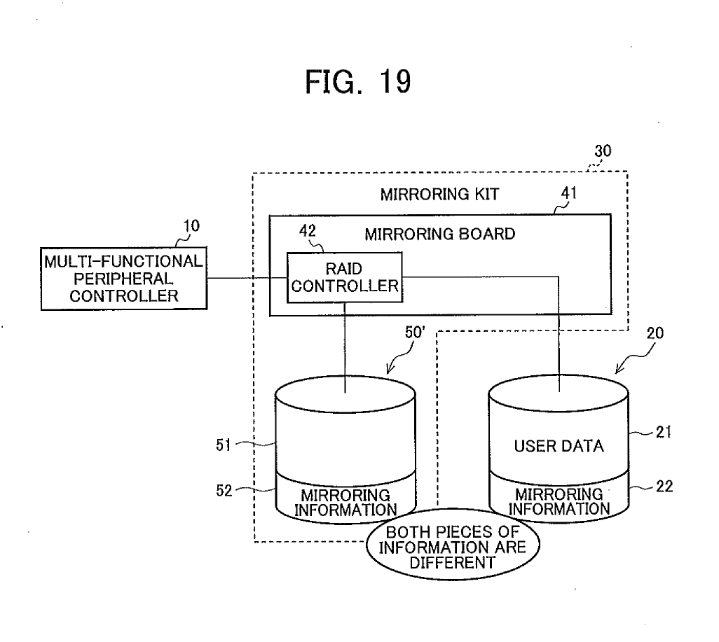

As a second point of the prohibited matters in installation and replacement of the HDD, it is prohibited to use an HDD which has an attachment history in the mirroring kit 30 for a multi-functional peripheral in which the mirroring kit 30 has been attached, in the event of failure of the HDD. The details thereof will be described with reference to FIG. 18 to FIG. 19. Here, description will also be given for a common state where the shared management information area according to the present invention is not provided as an example.

When there occurs failure in either one of the HDD 50 on the mirroring kit side or the HDD 20 on the multi-functional peripheral body side (for example, FIG. 8 to FIG. 9), the failed HDD is removed to be replaced with a new HDD. Here, it is assumed a case of failure of the HDD 50 on the mirroring kit side. As shown in FIG. 18, it is assumed that when the failed HDD 50 on the mirroring kit side is replaced with a new HDD 50′, the HDD 50′ after replacement is a used HDD having a use history in a multi-functional peripheral of other model.

In this case, there is mirroring information which has already been recorded in the multi-functional peripheral of the previous model in the used HDD 50′. Meanwhile, there is also mirroring information in the HDD 20 on the multi-functional peripheral body side. Each piece of mirroring information in these two HDDs 50′ and 20 does not correspond with one another.

In FIG. 19, at the time of activating a multi-functional peripheral in which the HDD is replaced with the used HDD 50′, the RAID controller 42 reads mirroring information from the two HDDs 50′ and 20 respectively for identification, however, becomes unable to perform identification since the both mirroring information is different from one another, so that it becomes impossible to activate the multi-functional peripheral. At the time, a user does not understand why the multi-functional peripheral cannot be activated. Therefore, it is prohibited to use the HDD which has the use history in a multi-functional peripheral of other model.

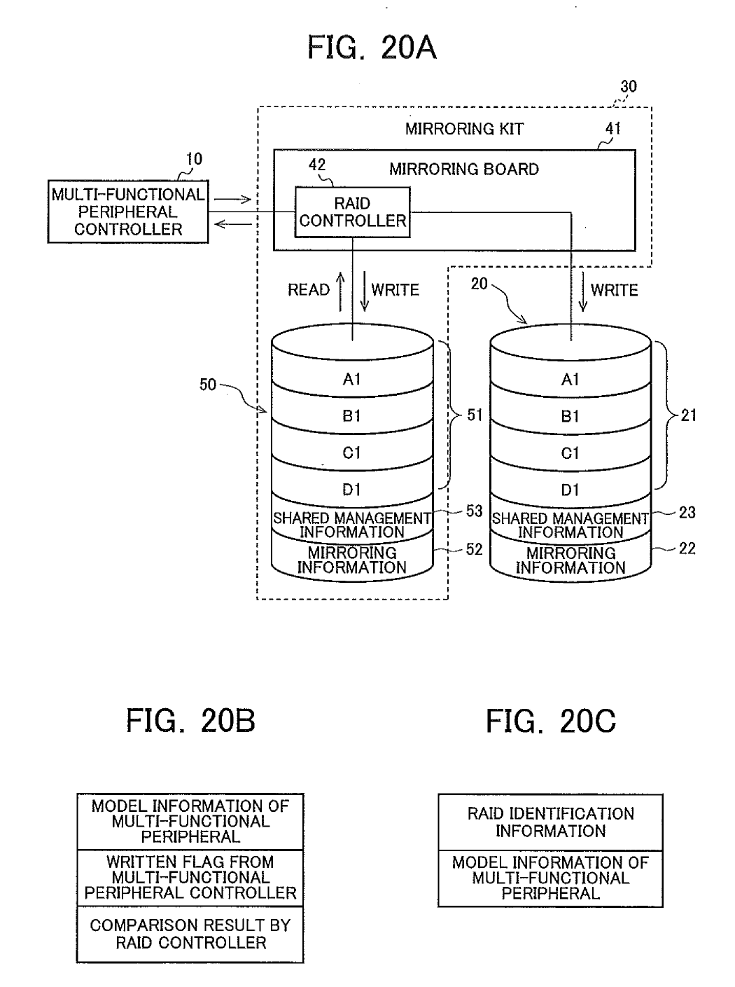

FIG. 20A, 20B and 20C are diagrams explaining a configuration of the RAID system in the embodiment of the present invention. As shown in FIG. 20A, the RAID system which is applied to the embodiment of the present invention is composed of a mirroring board 41 on which a RAID controller is mounted, and an HDD 50. Such the mirroring board 41 on which the RAID controller 42 is mounted and the HDD 50 constitute the mirroring kit 30.

The multi-functional peripheral 10 accesses the two HDDs 20 and 50 through the RAID controller 42 on the mirroring board 41. Further, mirroring information for identifying and managing the HDDs is written in the both mirroring information areas 22 and 52 of the both HDDs 20 and 50. With the mirroring information, even when there is failure occurred in one HDD, the information of the other HDD is able to be used, so that data loss will not be occurred even with the failure of the one HDD.

In the embodiment according to the present invention, parts of recording areas in the HDDs 20 and 50 are configured to serve as shared management information areas 23 and 53 to which both the multi-functional peripheral controller 10 and the RAID controller 42 are accessible, and management information shared by the both controllers 10 and 42 is recorded in the shared management information areas. For the shared management information, identification information such as model information of the multi-functional peripheral may be used. Description will be given hereinafter on the assumption that the model information of a multi-functional peripheral is used for the management information.

The multi-functional peripheral controller 10 records the management information including the model information of the multi-functional peripheral in the shared management information areas 23 and 53, at the time of activating the multi-functional peripheral Thereby, the both multi-functional peripheral controller 10 and the RAID controller 42 are able to share the management information including the model information of the multi-functional peripheral.

In FIG. 20B, a configuration of the management information to be stored in the shared management information areas of respective HDDs is shown. The management information to be stored in the shared management information areas 23 and 53 of the respective HDDs 20 and 50 includes model information of a multi-functional peripheral, a written flag from the multi-functional peripheral controller 10, and a comparison result from the RAID controller 42. As the model information of a multi-functional peripheral, a model name or data of a MAC address is recorded. Furthermore, as the written flag, for example, a flag of 0 in the case of before writing information by the multi-functional peripheral controller 10, and 1 in the case of after writing information are recorded.

Further, a comparison result of the RAID controller is information indicating a result of a comparison obtained by the RAID controller 42 between information in the mirroring information areas 22 and 52 of the respective HDDs 20 and 50 and management information in the shared management information areas 23 and 53. When the content of the information in the mirroring information areas 22 and 52 corresponds with that of the management information of the shared management information areas 23 and 53, it is normal, and in the case of not corresponding with each other, it is abnormal and falls under the prohibited matters. Moreover, when there is no mirroring information itself, the HDD is an unused one and it is thus also judged as normal. Such judgment information is stored.

In FIG. 20C, a configuration of mirroring information to be stored in the mirroring information areas of the respective HDDs is shown. The mirroring information is composed of RAID identification information and model information of a multi-functional peripheral. The RAID identification information is information for identifying and managing an HDD by the RAID. Additionally, the model information of the multi-functional peripheral is one in which the model information stored in the shared management information area by the multi-functional peripheral controller 10 is copied to the mirroring information areas 22 and 52 by the RAID controller 42. Further, in the HDD which has been used in other model in the past, information different from the management information of the shared management information is recorded in the mirroring information, in some cases.

In the above system, the RAID controller 42 compares information in the mirroring information areas 22 and 52 of the respective HDDs 20 and 50 with the management information in the shared management information areas 23 and 53, and determines whether the content corresponds with each other. Specifically, it is determined that the model information included in the management information corresponds with each other. Then, when the content thereof corresponds with each other, activation of the multi-functional peripheral is performed normally.

At this time, for example, when the mirroring kit 30 including an unused HDD 50 is attached, since there is no mirroring information in the mirroring information area 52 of the unused HDD 50, the RAID controller 42 thus copies the management information in the shared management information area 53 to the mirroring information area 52 so that the multi-functional peripheral is activated normally. In the case of having no mirroring information, it is shown that the HDD is new one or newly used in a RAID system, and therefore, in this case, the HDD is not judged as inappropriate, and it is possible to activate the multi-functional peripheral normally. It is assumed that such processing is performed similarly for the HDD 20 on the body side.

Then, when the RAID controller 42 compares the information of the mirroring information areas 22 and 52 of respective HDDs 20 and 50 with the management information of the shared management information areas 23 and 53, and the content corresponds with each other, the multi-functional peripheral controller 10 normally activates the multi-functional peripheral. Accordingly, when the HDD which is usable in the RAID is attached, the normal activation is possible to be performed.

Further, when the information in the mirroring information areas 22 and 52 of respective HDDs 20 and 50 does not correspond with the management information in the shared management information areas 23 and 53, the HDD is judged as having a history of being used in other model in the past. That is, the management information in the shared management information areas 23 and 53 is written by the multi-functional peripheral controller 10 when the multi-functional peripheral is powered on, however, as management information in the mirroring information areas 22 and 52, one which is initially copied from the shared management information areas 23 and 53 in a new condition exists in principle. Accordingly, in the case of having an appropriate HDD, the management information stored in the shared management information areas 23 and 53 and the management information stored in the mirroring information areas 22 and 52 correspond with each other.

In the case of not corresponding with each other, it is understood that there is the state where mirroring information of other model has been written when used in the model in the past. Accordingly, in such a case, a message is displayed on the display panel of the multi-functional peripheral for warning that the HDD is abnormal and not appropriate for constructing the RAID, and such HDD is separated from a control target. This message makes it possible to require to power off the multi-functional peripheral, and to require to erase the mirroring information of the HDD or to reformat the HDD. Thereby, the user is notified of the state of the HDD requested to address the state of the HDD while it is possible to prevent malfunction or the like of the machine.

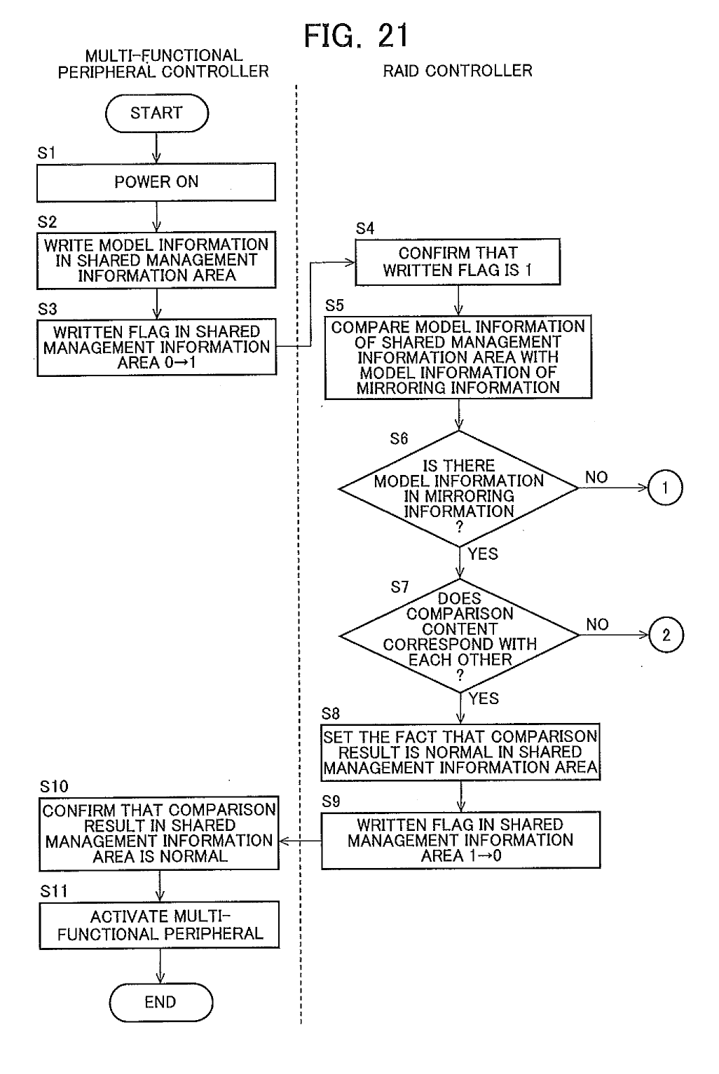

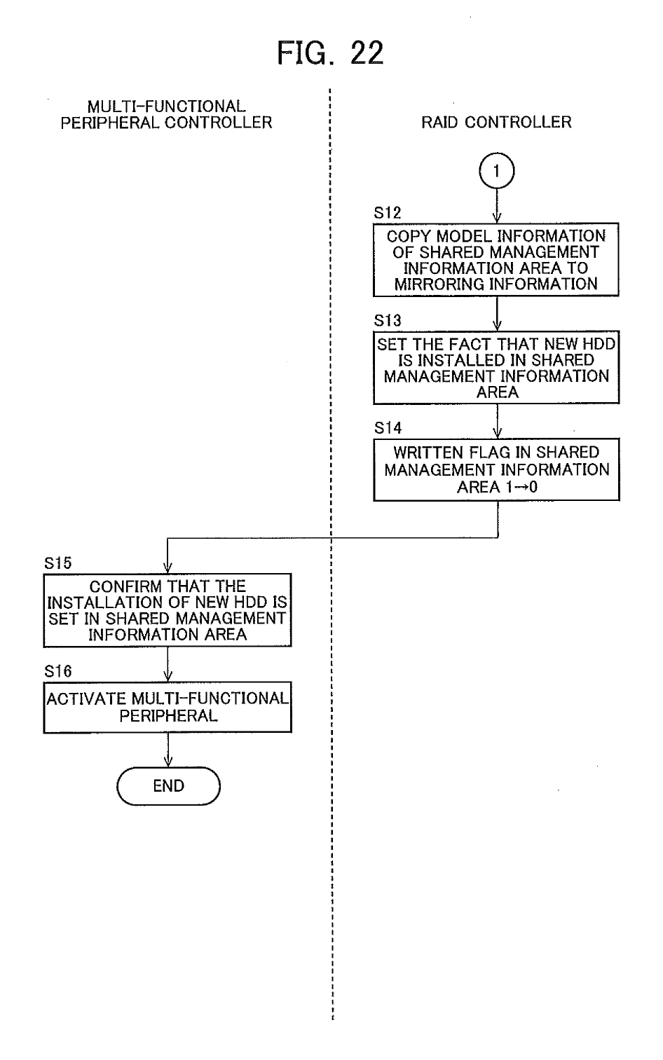

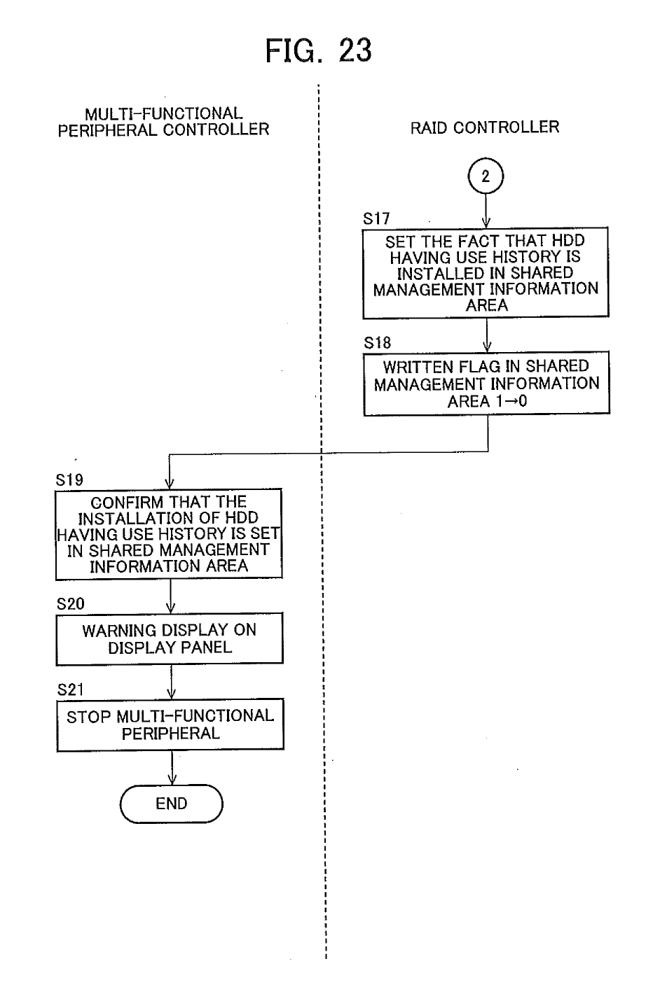

FIG. 21 to FIG. 23 are flowcharts for explaining a processing example of the image processing apparatus according to the present invention, and show flows performed by the multi-functional peripheral which is the embodiment of the image processing apparatus. Here, description will be given separately for processing of the multi-functional peripheral controller 10 and the RAID controller 42 with reference to the configuration of FIG. 6.

First, when the multi-functional peripheral is powered on by the multi-functional peripheral controller 10 (step S1), the multi-functional peripheral controller 10 writes model information which is one of the shared management information in both the shared management information area 23 of the HDD 20 on the multi-functional peripheral side and the shared management information area 53 of the HDD 50 on the mirroring kit side (step S2). An arrangement should be made in advance that the respective shared management information areas 23 and 53 are areas to be accessed by the both multi-functional peripheral controller 10 and RAID controller 42.

The multi-functional peripheral controller 10 then sets written flags of the respective shared management information areas 23 and 53 from 0 to 1 (step S3).

After powering on the multi-functional peripheral, the RAID controller 42 performs polling until the written flag becomes 0 to 1, and confirms that the written flag is 1 (step S4). The RAID controller 42 then reads the model information of the shared management information areas 23 and 53, and compares the read model information with the model information stored as the mirroring information in the mirroring information areas 22 and 52 (step S5).

The RAID controller 42 then determines whether or not there is the model information in a model information area of the mirroring information (step S6), and judges whether a comparison result shows correspondence when there is the model information between above two pieces of information (step S7). Here, in the case where the comparison result shows correspondence, the RAID controller 42 sets in an area showing a comparison result by the RAID controller in the shared management information areas 53 and 23 that the comparison result is normal (step S8). The RAID controller 42, then, sets the written flags of the shared management information areas 53 and 23 from 1 to 0 (step S9).

The multi-functional peripheral controller 10 performs polling until the written flag of the shared management information becomes from 1 to 0, and when it becomes 0, it is possible to confirm that the comparison results set in the shared management information areas 53 and 23 are normal (step S10). Then, the multi-functional peripheral controller 10 activates the multi-functional peripheral (step S11). The activation of the multi-functional peripheral here means to activate it up to a state of being usable.

When there is no model information in the model information area of the mirroring information at step S6, the RAID controller 42 copies the model information in the shared management information area to the model information area in the mirroring information area (step S12). The RAID controller 42 then sets in the shared management information area that a new HDD is installed according to the comparison result by the RAID controller (step S13), and sets the written flag in the shared management information area from 1 to 0 (step S14).

The multi-functional peripheral controller 10 performs polling until the written flag of the shared management information area becomes from 1 to 0, and when it is 0, it is possible to confirm in the shared management information area that a new HDD is installed (step S15). Then, the multi-functional peripheral controller 10 activates the multi-functional peripheral (step S16).

At the above step S7, when the comparison result between the model information in the shared management information areas 23 and 53 and the model information in the mirroring information areas 22 and 52 does not show correspondence, the RAID controller 42 sets in the shared management information area that the HDD having a use history is installed, as the comparison result of the RAID controller with respect to the HDD having the comparison result which do not show correspondence (step S17), and sets the written flag of the shared management information area from 1 to 0 (step S18).

The multi-functional peripheral controller 10 performs polling until the written flag of the shared management information area becomes from 1 to 0, and when it is 0, it is possible to confirm that the HDD with the use history in the shared management information area is installed (step S19). The multi-functional peripheral controller 10, then displays on the display panel for warning that the used HDD is connected (step S20). Thereafter, the multi-functional peripheral controller 10 stops the multi-functional peripheral (step S21). The stop, here, means to bring the multi-functional peripheral into a state of being unusable as the multi-functional peripheral, and the RAID controller 42 separates the HDD from the control target so that the HDD becomes not usable. Thereby, when an inappropriate HDD is installed, it is possible to draw a user's attention to formatting or the like and to prevent malfunction or the like of the machine.

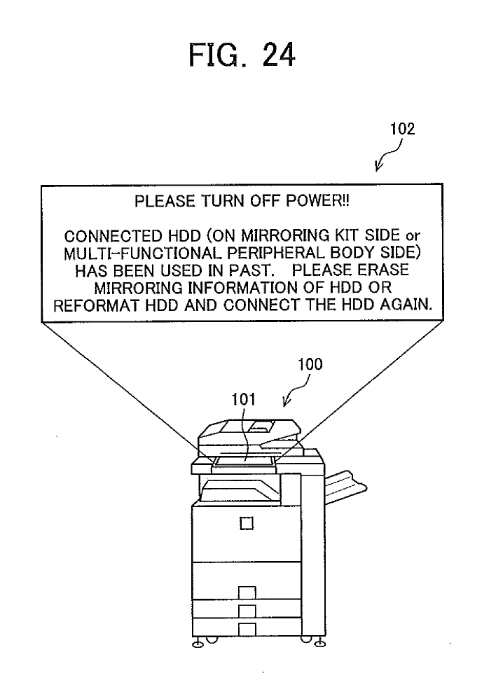

FIG. 24 is a diagram showing a display example of a display panel of a multi-functional peripheral at the time of attaching a used HDD having a use history. A multi-functional peripheral 100 includes a display panel 101. When the HDD having a used history is attached, warning display 102 is displayed on the display panel 101. On the warning display 102, it is possible to require a user to powering off, notify the user of that the connected HDD has been used in the past, and require the user to erase the mirroring information of the HDD or to reformat the HDD.

By mounting the system as described above, in the case of attaching the HDD having a use history, since model information in shared management information of an attached HDD is different from model information in mirroring information, user's attention is drawn to connect another HDD, while a RAID controller separates the HDD. Thereby, data will not be overwritten by user data of other HDD. That is, even when a used HDD having a use history in the past is newly attached to a multi-functional peripheral and the multi-functional peripheral is powered on, data of a user will not be erased.

Hereinabove, according to the present invention, it is possible to provide the image processing apparatus which includes the management information which can be shared by the RAID controller and the controller of the image processing apparatus, and copies specific management information to mirroring information of an HDD, so that appropriate judgment is made whether or not the HDD is normal by comparing shared management information with the mirroring information, thus managing and operating the HDD safely.

1. An image processing apparatus comprising:
an image processing apparatus controller for controlling an operation of an image processing apparatus body;
a plurality of HDDs constituting RAID; and
a RAID controller for controlling the plurality of HDDs, wherein
a part of a storage area of each of the HDDs serves as a shared management information area which is able to be accessed by both the image processing apparatus controller and the RAID controller,
the RAID controller controls mirroring among the plurality of HDDs as well as storing mirroring information for identifying and managing each of the HDDs in each of the HDDs, and copies specific management information stored in the shared management information area in an area where the mirroring information is stored.

2. The image processing apparatus as defined in claim 1, wherein,
the image processing apparatus controller records, at the time of activating the image processing apparatus, predetermined identification information of the image processing apparatus in the shared management information area as the specific management information, and
the RAID controller compares, in each of the HDDs, information in the area where mirroring information is stored with the identification information recorded in the shared management information area at the time of the activation and judges whether or not the HDD as a target of the comparison is a normal HDD for constituting the RAID based on a result of the comparison.

3. The image processing apparatus as defined in claim 2, wherein,
a display panel for displaying information is included,
the RAID controller compares the specific management information copied in the past which is in the area where the mirroring information is stored with the specific management information stored in the shared management information area at the time of the activation, and judges, when a result of the comparison does not show correspondence, that the HDD to be a target for the comparison is abnormal, and
the image processing apparatus controller performs warning display on the display panel according to the judgment by the RAID controller and separates the HDD which has been judged as abnormal from the control target.

4. The image processing apparatus as defined in claim 2, wherein,
the RAID controller judges, when the specific management information is not recorded in the area where the mirroring information is stored, that the HDD as a target for the comparison is normal, and copies the specific management information stored in the shared management information area in the area where the mirroring information is stored, and
the image processing apparatus controller normally activates the image processing apparatus according to the judgment by the RAID controller.

5. The image processing apparatus as defined in claim 2, wherein,
the RAID controller compares the specific management information copied in the past which is in the area where the mirroring information is stored with the specific management information stored in the shared management information area at the time of the activation, and judges, when a result of the comparison shows correspondence, that the HDD to be a target for the comparison is normal, and
the image processing apparatus controller normally activates the image processing apparatus according to the judgment of the RAID controller.
